(19) United States
(12) Patent Application Publication
(10) Pub. No.: US 2009/0262600 A1
(43) Pub. Date: Oct. 22, 2009

(54) METHODS AND APPARATUS FOR SURVEILLANCE SONAR SYSTEMS

(76) Inventors: Guy T. Railey, Middletown, RI (US); Jeffrey C. Yancho, Assonet, MA (US)

Correspondence Address: RAYTHEON COMPANY;C/O DALY, CROWLEY, MOFFORD & DURKEE, LLP, 354A TURNPIKE STREET, SUITE 301A, CANTON, MA, 02021, US

(21) Appl. No.: 11/690,938

(22) Filed: Mar. 26, 2007

(51) Int. Cl. H04B 1/59

(52) U.S. Cl. 367/5

(57) ABSTRACT

Methods and apparatus to provide sonobuoys that can be deployed on a sea bottom and surface upon detection of an object of interest. Upon reaching the surface, the sonobuoy can transmit information, such as position information, to a receiver on an aircraft, satellite, and/or remote location.

### BACKGROUND

As is known in the art, sonar can be used to detect submarines and other underwater objects. Submarines can utilize active and passive sonar to detect other submarines, ships, and the like. As is well known in the art, passive detection of relatively quiet objects, such as diesel submarines can be challenging, particularly in relatively shallow water due to the low noise signature.

Surface ship sonar systems have limitations due to the physics of shallow water acoustics. So-called helicopter dipping sonar systems have slow area search rates and are vulnerable to attack from surface-to-air weapons. Other known sonar systems include arrays of sonobuoys placed at the sea bottom. Such arrays can be deployed using aircraft or ships. However, such arrays are costly to develop, install, and maintain. For arrays of physically coupled sonobuoys, there are significant power and maintenance issues. In addition, such arrays have limited coverage area. Air-dropped sonobuoys are limited to line of sight with a host platform, have limited useful life due to the required constant communication with the host, and have poor localization capability since they can only localize a detected submarine using complex multi-static processing with triangulation from a plurality of sonobuoys.

### SUMMARY

The present invention provides methods and apparatus for sonobuoys to be deployed on a sea bottom wherein sonobuoys surface upon detection of an object of interest, such as a submarine. With this arrangement, a relatively large number of sonobuoys can be placed in an area to provide wide area coverage at a low cost with quick installation via air, surface or subsurface platforms. While the invention is primarily shown and described in conjunction with submarine detection, it is understood that the invention is applicable to sonar surveillance systems in general in which it is desirable to detect an object.

In one aspect of the invention, a system includes a plurality of sonobuoys dispersed below a water surface, at least one of the plurality of sonobuoys to surface upon detection of an object of interest.

The system can further including one or more of the following features: the at least one of the plurality of sonobuoys includes a transmitter to transmit from the surface, the transmitter can transmit position information, the transmitter can transmit depth information for the object of interest, the transmitter can transmit GPS information, the transmitter can transmit light, the object of interest includes a submarine, at least one of the plurality of sonobuoys includes a signal processing module for the detection of the object of interest and a release mechanism to release the sonobuoy from a tether adapted for connection to an anchor, and the anchor includes a battery.

In another aspect of the invention, a method includes placing sonobuoys in an area on a sea bottom, wherein the sonobuoys surface upon detection of an object of interest. The method can further include one or more of the following features: receiving information transmitted from a sea surface by one of the sonobuoys released from a tether after detection of an object of interest, the information includes position information.

In a further aspect of the invention, a device includes a sonobuoy having a positive buoyancy, the sonobuoy including: a receiver to receive contact information, a signal processing module to determine if the contact information indicates that an object of interest has been detected, a release mechanism to release the sonobuoy from a tether when the object of interest is detected, and a transmitter to transmit information into air.

The device can further include one or more of the following features: the sonobuoy includes a connector to receive energy from a battery through the tether, wherein the battery can be contained in an anchor coupled to the tether, the transmitter includes a device to transmit light, the information includes position information, the information includes object of interest information including depth, the sonobuoy has a size in a range from about 0.5 inch to about 5.0 inches, and the sonobuoy coves an area that is generally cone-shaped.

### BRIEF DESCRIPTION OF THE DRAWINGS

The foregoing features of this invention, as well as the invention itself, may be more fully understood from the following description of the drawings in which:

FIG. 1 is a pictorial representation of an exemplary sonar surveillance system 100 having a series of sonobuoys scattered over an area in accordance with exemplary embodiments of the invention;

FIG. 1A is a pictorial representation looking down into the water for the system of FIG. 1;

FIG. 2 is a block diagram of an exemplary sonobuoy in accordance with exemplary embodiments of the invention;

FIG. 3 is a schematic representation of exemplary sonobuoy functionality in accordance with exemplary embodiments of the invention; and

FIG. 4 is a flow diagram of an exemplary set of steps to provide a sonar surveillance system in accordance with exemplary embodiments of the invention.

### DETAILED DESCRIPTION

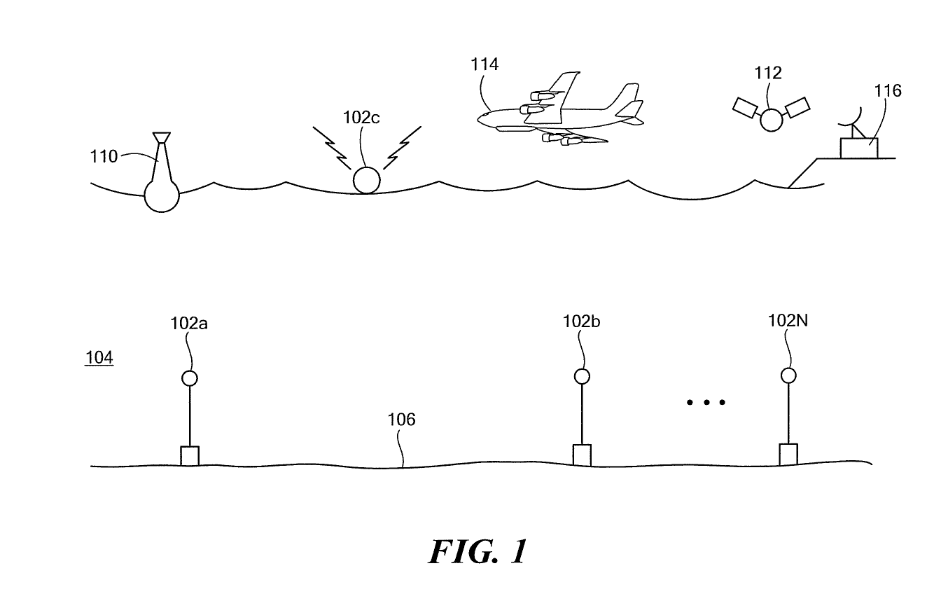

FIGS. 1 and 1A show a sonar surveillance system 100 having a plurality of sonobuoys 102a-N scattered over an area 104. In general, the sonobuoys 102 are tethered to the bottom 106 of the sea. When a sonobuoy 102 detects an object of interest meeting certain criteria, the sonobuoy, shown as sonobuoy 102c, releases from the tether and floats to the surface 108. Upon reaching the surface 108, the sonobuoy 102c transmits a signal with position information, for example, which can include GPS (Global Positioning Satellite) coordinates.

In an exemplary embodiment, a communication buoy 110 is located within a range of surfaced sonobuoys 102 to relay position information from the surfaced sonobuoys to a satellite 112, aircraft 114, and/or remote receiver 116. In an alternative embodiment, the sonobuoys 102 transmit directly to the aircraft 114 or other receiver.

The sonobuoys 102 have a positive buoyancy so that they stay off the sea floor and float to the surface when released from the tether. It will be readily understood that rising to the surface significantly increases the ability of the sonobuoy to transmit information to a variety of receivers via an air interface. The sonobuoys 102 can also be programmable to stay submerged until an acoustic release signal is received.

In one embodiment, the sonobuoys are relatively inexpensive so that a relatively large number of sonobuoys can be economically deployed. In addition, retrieving the sonobuoys is relatively low priority due to the minimal cost. With this arrangement, large areas can be monitored with a high level of confidence as to whether submarines or other objects have passed through the area.

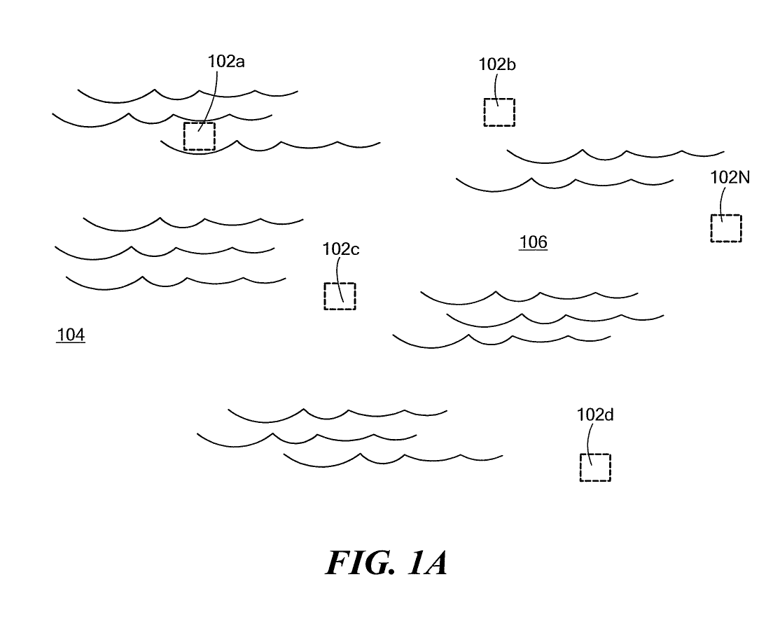

FIG. 2 shows an exemplary sonobuoy 200 in accordance with an exemplary embodiment of the invention. The sonobuoy 200 includes a housing 202, which can be releasably coupled to a tether 204. A battery 206 can be placed within an anchor 208 to supply power to the sonobuoy 200. The tether 204 includes a path for an electrical connection between the battery 206 and the housing 202.

In an exemplary embodiment, the sonobuoy 200 includes a transducer 210 to transmit and/or receive energy from a desired area 250 and a signal processing module 212 to process received energy and to determine whether a submarine has been detected, as described more fully below. Upon detection of an object of interest meeting the selected criteria, a release mechanism 214 is activated to release the housing 202 from the tether 204. Once the surface is reached, a transmitter module 216 can transmit position, e.g., GPS information, target information, e.g., depth, length, etc, and/or time.

In one embodiment, the sonobuoys 200 operate in a passive mode, i.e., they do not radiate energy to detect objects. In another embodiment, the sonobuoys 200 operate in an active mode, i.e., they use active sonar to transmit energy and process signal return to detect objects. Passive and active sonar systems are well known to one of ordinary skill in the art. One of ordinary skill can readily determine desirable characteristics and parameters for an active and/or passive sonar system to meet the requirements of exemplary embodiments shown and described herein. In addition, it is understood that various parameters can be programmed, selected, and/or dynamically adapted based upon detection performance, remote instruction, or other input.

It is understood that the area 250 can be defined to meet the needs of a particular application. In an exemplary embodiment, the area 250 corresponds to a cone-shape in the order of 100 meters by 200 meters. In other embodiments, the cone-shape has other dimensions to meet the needs of a particular application. To eliminate detection of ships or other surface objects, in one embodiment, the area 250 is limited to more than about fifty feet, for example, below the water surface. The detection area can be readily limited in a manner well known to one of ordinary skill in the art. In general, operating criteria can be selected to detect specified targets.

It is understood that the transducer can be provided in a variety of forms. While a relatively low cost transducer may be the least costly, other device types can be used, such as vertical and/or horizontal arrays having hydrophones/transducers. As is known in the art, the array can have a length corresponding to a frequency selected for signal detection.

The release mechanism 214 can include any suitable mechanism to securely keep the sonobuoy 200 coupled to the anchor 208 and to reliably release the sonobuoy upon activation. In an exemplary embodiment, the release mechanism includes a power coupling to the battery. The power coupling provides mechanical connection to the tether and also provides simple mechanical detachment via command.

Other embodiments of the release mechanism include detachment from the tether provided by stored mechanical energy and/or by squib.

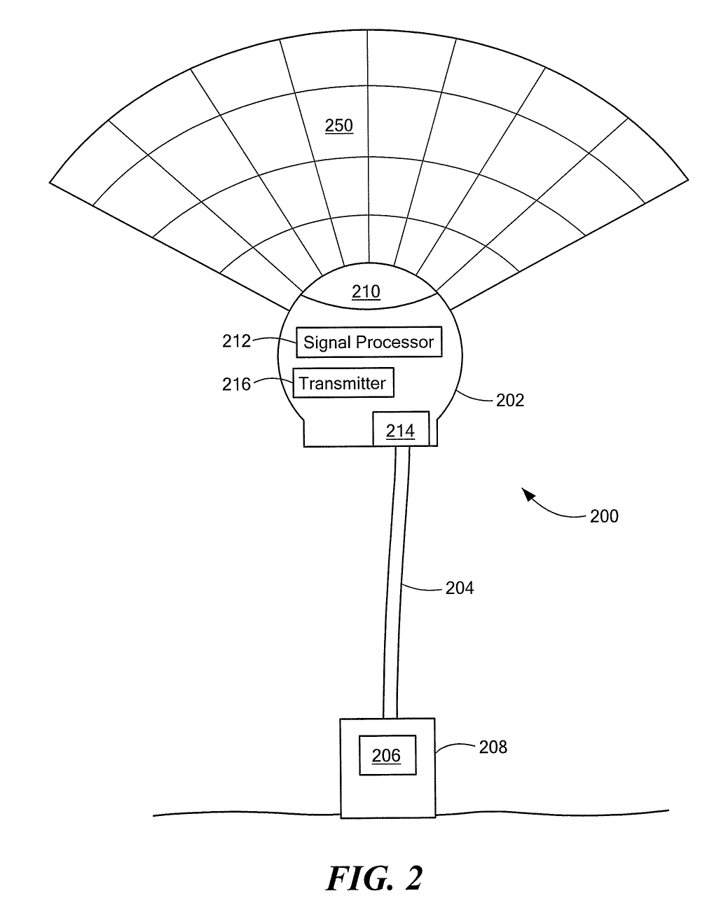

FIG. 3 shows an exemplary schematic for a sonobuoy 300 in accordance with an exemplary embodiment of the invention. The sonobuoy includes a processor 302 and a memory 304 supported by an operating system 306. A signal processing module 308 processes information from a transducer module 310 to detect targets, such as submarines. Transducers for sonar applications are well known to one of ordinary skill in the art.

Upon determining that a submarine has been detected, the signal processing module 308 communicates to a release module 312 to effect release of the sonobuoy from the tether. After the sonobuoy has surfaced, the transmitter module 314 is activated to begin transmission of position information, such as GPS location, and/or contact information for the detected target.

In one embodiment, the sonobuoy 300 transmits target information, e.g., depth, in addition to position information. The target information may be further processed at a remote location. Such processing may produce a confidence level regarding whether the target is in fact a submarine. In addition, the target information may be combined with information from other sonobuoys and/or other resources.

In a further embodiment, the sonobuoy includes a magnetic field detector to reduce false alarms. As will be appreciated by one of ordinary skill in the art, a submarine, which has a metal hull, will perturb the magnetic field proximate the sonobuoy. If the contact is not a submarine, i.e., not metal, the magnetic field detector may not detect the contact.

In general, the sonobuoy detection range can vary to meet the needs of particular application, such as battery life, cost, target profile, etc. In an exemplary embodiment, the sonobuoy detection range is up to about 100 m and the sonobuoy deployment depth is about 10 m to about 1000 m.

It is understood that a variety of battery types can be used. The battery stores energy to effect storage and deployment of the tether. In one particular embodiment, the battery provides sufficient energy to maintain operation from about 400 to about 1000 hours depending on the mode of operation. In addition, the battery can be supplemented by additional sources of power derived from the ocean, such as currents.

It is understood that a wide variety of signal types can be transmitted by the sonobuoy from the water surface. Exemplary signal types includes wireless links, light, sound, low frequency energy, odor etc. For example, beacon flashes can be generated for detection by aircraft and/or satellite. In general, any type of suitable energy can be transmitted to meet the needs of a particular application.

In general, the dimensions and geometry of the sonobuoy can vary to meet the needs of a particular application. In an exemplary embodiment, the sonobuoy has a size in the order of a golf ball. The sonobuoy can have an exemplary range from about 0.5 inch to about 5.0 inches in diameter or length/width. This relatively small size enables the sonobuoys to be readily deployed by air, surface and subsurface platforms.

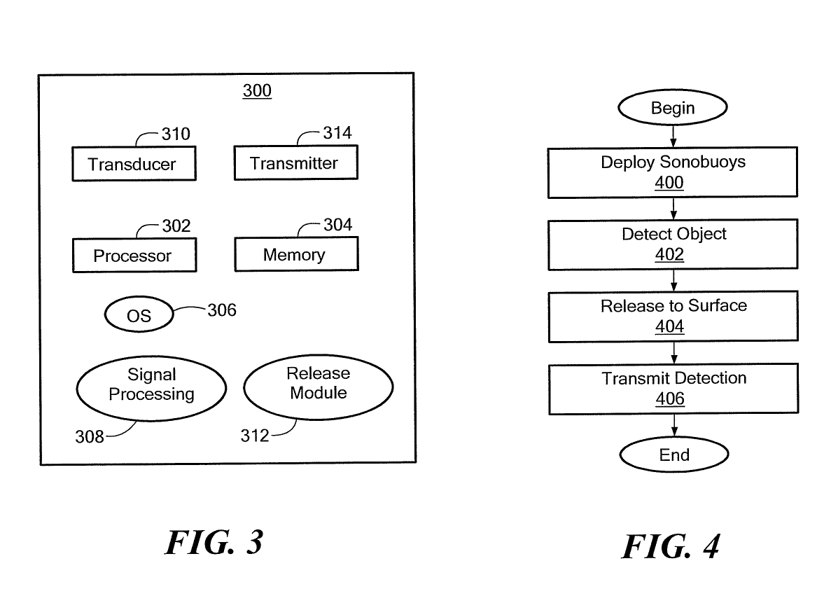

FIG. 4 shows an exemplary sequence of steps for providing sonar surveillance in accordance with exemplary embodiments of the invention. In step 400, a series of sonobuoys are deployed on a sea floor. The sonobuoys are placed to cover an area in which detection of objects, e.g., submarines, meeting specified criteria are met. In step 402, an object, e.g., submarine, is detected by one or more of the sonobuoys. The sonobuoy that detected the object then releases from a tether in step 404 and floats to the surface. In step 406, the sonobuoy transmits detection information, such as GPS position, to a remote buoy, satellite, aircraft, ship, submarine, etc.

While an exemplary implementation is shown and described, it is understood that a variety of partitions between hardware and software to provide the described functionality will be readily apparent to one of ordinary skill in the art. Suitable programming languages will be readily apparent to one skilled in the art.

While the invention is primarily shown and described in conjunction with detecting submarines, it is understood that the invention is applicable to sonar surveillance applications in general. For example, a sonar surveillance system can be deployed to protect selected fishing grounds. In this application, the sonobuoys can be configured to detect ships and/or nets. Upon such a detection, a sonobuoy can surface and transmit an alert signal to the Coast Guard or other agency. In another embodiment, a sonar surveillance system can be configured to detect whales or other animals for tracking migration patterns and the like.

Having described exemplary embodiments of the invention, it will now become apparent to one of ordinary skill in the art that other embodiments incorporating their concepts may also be used. The embodiments contained herein should not be limited to disclosed embodiments but rather should be limited only by the spirit and scope of the appended claims. All publications and references cited herein are expressly incorporated herein by reference in their entirety.

What is claimed is:

1. A system, comprising:
a plurality of sonobuoys dispersed below a water surface, at least one of the plurality of sonobuoys to surface upon detection of an object of interest.

2. The system according to claim 1, wherein the at least one of the plurality of sonobuoys includes a transmitter to transmit from the surface.

3. The system according to claim 2, wherein the transmitter can transmit position information.

4. The system according to claim 2, wherein the transmitter can transmit depth information for the object of interest.

5. The system according to claim 2, wherein the transmitter can selectively transmit GPS information.

6. The system according to claim 2, wherein the transmitter can transmit light.

7. The system according to claim 1, wherein the object of interest includes a submarine.

8. The system according to claim 1, wherein the at least one of the plurality of sonobuoys includes a signal processing module for the detection of the object of interest and a release mechanism to release the sonobuoy from a tether adapted for connection to an anchor.

9. The system according to claim 8, wherein the anchor includes a battery, tether and deployment mechanism for deployment of the tether.

10. A method, comprising:
placing sonobuoys in an area on a sea bottom, wherein the sonobuoys surface upon detection of an object of interest.

11. The method according to claim 10, further including receiving information transmitted from a sea surface by one of the sonobuoys released from a tether after detection of an object of interest.

12. The method according to claim 11, wherein the information includes position information.

13. A device, comprising:
a sonobuoy having a positive buoyancy, the sonobuoy including:
a receiver to receive contact information;
a signal processing module to determine if the contact information indicates that an object of interest has been detected;
a release mechanism to release the sonobuoy from a tether when the object of interest is detected; and
a transmitter to transmit information into air.

14. The device according to claim 13, wherein the sonobuoy includes a connector to receive energy from a battery through the tether, wherein the battery can be contained in an anchor coupled to the tether.

15. The device according to claim 13, wherein the transmitter includes a device to selectively transmit light.

16. The device according to claim 13, wherein the information includes position information.

17. The device according to claim 13, wherein the information includes object of interest information including depth.

18. The device according to claim 13, wherein the sonobuoy has a size in a range from about 0.5 inch to about 5.0 inches

19. The device according to claim 13, wherein the sonobuoy coves an area that is generally cone-shaped.
